(19) United States
(12) Patent Application Publication
(10) Pub. No.: US 2022/0322849 A1
(43) Pub. Date: Oct. 13, 2022

(54) Flexible Personal Barrier Device

(71) Applicants: Baron Thrower, Owings Mills, MD (US); Debra Thrower, Owings Mills, MD (US)

(72) Inventors: Baron Thrower, Owings Mills, MD (US); Debra Thrower, Owings Mills, MD (US)

(21) Appl. No.: 17/711,129

(22) Filed: Apr. 1, 2022

Related U.S. Application Data
(60) Provisional application No. 63/174,198, filed on Apr. 13, 2021.

(51) Int. Cl. A47G 5/00; F21V 33/00

(52) U.S. Cl. CPC A47G 5/00; F21V 33/0064; F21Y 2115/10

(57) ABSTRACT

The present invention relates to a flexible shield or guarding barrier device configured to protect a meal or work area from pathogens and accidental spills from beverage containers. The device is a lightweight and portable device that features an angular adjustable shield and a flat base. The flat base in positioned around the edge/rim of a plate or bowl having a meal or working area and the angular adjustable shield is pivotally-coupled to the flat base, thereby enabling a user to move the shield to protect the meal or work area. The shield in a closed state which makes a 10-20 degree angle with the base to maintain maximum coverage of the plate or work area when not in use.

### CROSS-REFERENCE TO RELATED APPLICATION

The present application claims priority to, and the benefit of, U.S. Provisional Application No. 63/174,198, which was filed on Apr. 13, 2021, and is incorporated herein by reference in its entirety.

### FIELD OF THE INVENTION

The present invention relates generally to the field of personal protection devices. More specifically, the present invention relates to a flexible shield or guard designed to be positioned around the rim of a plate, bowl or other eating or working surface to help reduce the spread of germs, viruses, particulate and bacteria on the meal, eating or working surface. The invention has an angular adjustable shield and a flat base. The adjustable shield is pivotally-attached to a base allowing the shield to move in between a first or open position and a second or closed position. The base sits flat on the table to balance the shield and prevent it from tilting or tipping over. Users can adjust the angle of the shield to maximize coverage over the top of the plate, eating or working surface. Accordingly, the present disclosure makes specific reference thereto. Nonetheless, it is to be appreciated that aspects of the present invention are also equally applicable to other like applications, devices and methods of manufacture.

### BACKGROUND

By way of background, contamination describes a situation of the presence of unwanted elements or contaminants that are not appropriate for use. Usually, food contamination happens when foreign particles such as pathogens, dirt, chemicals, particulates and other harmful substances are present. Especially, food contamination in public places is a challenge and can lead to food-borne diseases, illness, and sickness.

In restaurants and other public eating areas, food served on plates, bowls and other eating surfaces may be left out in the open, unprotected and uncovered. Further, when the food is being consumed by a user, accidental spills from beverage and other containers placed on the table can contaminate the food. In cases where multiple users are eating food on a table, germs, viruses, particulates, and bacteria can be sprayed onto food if someone coughs or sneezes without fully covering his or her mouth and germs can spread even through casual conversation. In the times of pandemic, protection of food while serving and consuming from airborne pathogens is also desired.

Presently, people either protect their food using their hands or by moving their food away from the source of contamination. These methods are not only ineffective but can lead to contamination and waste of food.

Therefore, there exists a long felt need in the art for a meal-protecting device that protects the meal and food served on a plate or other eating surfaces from pathogens, bacteria, germs, particulates and other undesirable elements. There is also a long felt need in the art for a meal shield that can be used for protecting the meal and food from accidental spills of beverage and condiments containers. Additionally, there is a long felt need in the art for a meal or impurity barrier that provides an effective barrier from contamination while allowing the consumer to enjoy the food without concern about germs. Moreover, there is a long felt need in the art for a meal shield that eliminates the food to remain open in the air and easily accessible to the consumer. Further, there is a long felt need in the art for a meal shield or guard that is lightweight and is easy to carry. Finally, there is a long felt need in the art for a meal protection device that helps reduce the spread of germs, viruses, particulates and bacteria, especially useful in public eating spaces like restaurants, bars and other gathering areas.

The subject matter disclosed and claimed herein, in one embodiment thereof, comprises a flexible meal shield or guard. The flexible meal shield or guard is designed to be placed or positioned around the rim of a plate, bowl or other eating surface for preventing airborne particulates, particulates and debris from contaminating a meal placed in the plate or eating surface. The shield or guard of the present invention has an angular shield with an inner concave curvature and an outer convex curvature and a semi-circular base designed to conform to a portion of the plate, bowl or other eating utensil. The angular shield is configured to pivotally move, relative to the flat base between an open position and a closed position to protect food and beverages while allowing the consumer to enjoy the meal or beverage.

In this manner, the novel flexible meal shield or guard of the present invention accomplishes all of the forgoing objectives, and provides a relatively effective, portable and convenient solution to protect or guard food and meals served and consumed on a plate, bowl or other eating surface. The device protects the food or beverage from contamination while allowing a consumer to eat food and enjoy their beverages. The device is designed to prevent unsanitary particles, germs, bacteria and other impurities from reaching food and beverages and causing illness to the consumer.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a flexible meal shield or guard. The flexible meal shield or guard is designed to place around the rim of a plate or bowl or for protecting an eating surface by preventing airborne particulates and debris from contaminating food or beverage placed in the plate or in another eating area. The shield or guard further comprises an angular shield having an inner concave curvature and an outer convex curvature. The angular shield having a curved bottom edge and a hole at each end of a circumferential edge, a semi-circular flat base designed to conform to a portion of the plate, bowl, eating utensil or surface, a first pair of hinged slots positioned at a first curved end of the flat base and a second pair of hinged slots positioned at a second curved end of the base. The hinged slots of each pair have an aligned hole for receiving a cam-based pin, each pair of the hinged slots has a gap between the hinged slots for receiving a hole positioned at circumferential edge(s) of the angular shield, such that the angular shield is pivotally-fixed to the base, thereby enabling the angular shield to pivotally move relative to the flat base.

In yet another embodiment of the present invention, a meal shield or guarding device for protecting food or beverages that has been placed on a plate from pathogens and accidental spills of a drink or other items is disclosed. The meal shield and guarding device includes a dome-shaped angular shield pivotally coupled to a semi-circular base. The base may be weighted, flat or have feet, depending on the base or platform for positioning the guard or shield on a surface. The angular shield or guard is configured to be in a closed position, where the closed position corresponds to the angular shield, making roughly a 10-20 degree angle relative to the base. The angular shield is also configured to be in an open position where the open position corresponds to the angular shield making roughly a 70-90 degree angle relative to the base. The angular shield can be secured to any position between the open position and the closed position or first and second positions.

In yet another embodiment of the present invention, the angular shield substantially covers the plate, bowl or eating surface and the meal when in the closed or second position, and enables a consumer to consume the meal in the first or open position.

In yet another embodiment of the present invention, the dome-shaped angular shield or guard is pivotally-coupled to the base using a cam-based pin. The pin provides a frictional force to stop the angular shield in any desired position between the fully open position and the fully closed position.

In yet another embodiment of the present invention, the base is non-slipping and conforms to the shape of the plate, bowl or other eating utensil. The base may have a rubberized surface to grip onto a table or other platform on which the base is placed or may have a reusable adhesive which is covered by a liner material which when removed exposes the adhesive, thereby allowing the shield to be positioned on the table or other surface. The base may also include a plurality of layers of adhesive and release liners so that a new adhesive layer can be exposed with each use, thereby improving the sanitary conditions of the guard or shield.

In yet another embodiment, the angular shield protects the meal, food or beverages from pathogens, germs and any accidental spill from a direction opposite to the consumer who is consuming the meal from the plate or other surface or utensil.

In yet another embodiment, the meal shield device is made from thin, lightweight and durable plastic or Plexiglass. The shield may be transparent, translucent or opaque. The shield may also be provided with various indicia, graphics, or the like to further personalize the shield. In addition, the shield may be provided with an LED light, a movable indicator such as a sign, allowing the user to signal wait staff that they require attention, such as to order additional food or beverages as the shield may prevent the wait staff from seeing that the meal has been completed.

In a further embodiment of the present invention, a method for preventing a meal, food or beverages placed in a serving area is disclosed. The method includes providing a serving area shield or guarding device having a generally dome-shaped angular shield and a semi-circular base, and then placing the flat base along a portion of the rim of the plate or outer edge of the serving area. Next, the angular shield or guard is positioned in a closed position and the angular shield or guard covers the plate or serving area and the meal, and finally pivotally moving the angular shield relative to the flat base for consuming the meal.

The advantage of the meal shield or guarding device of the present invention is that it allows users to help reduce the spread of germs, viruses, particulates and bacteria, especially useful in public eating spaces. The device is flexible, lightweight, and protects the meal, food, beverages and food surfaces from pathogens, while allowing the consumer to consume the meal. The device comes in a variety of sizes, colors, and designs to fit various plates and bowls. The shield or guard may also be used to protect a work space such as when someone is working on laptop, reading a book, magazine or newspaper, texting, reading or watching things on a smartphone or the like.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the flexible personal barrier device of the present invention in an assembled state in accordance with the disclosed architecture;

FIG. 2A illustrates a perspective view of one potential embodiment of the personal barrier device of the present invention in an unassembled state in accordance with the disclosed architecture;

FIG. 2B illustrates a perspective view of one potential embodiment of the base of the shield or guard and showing a multiple layer adhesive configuration, as well as feet for an alternate configuration;

FIG. 3A illustrates a perspective view of one potential embodiment of the meal protective device of the present invention in a closed state in accordance with the disclosed architecture;

FIG. 3B illustrates a perspective view of one potential embodiment of the meal protective device of the present invention in an open state in accordance with the disclosed architecture;

FIG. 4 illustrates a side perspective view of two individuals consuming meals from their respective plates, wherein the meals are each protected by one potential embodiment of the meal protective device of the present invention in an open state in accordance with the disclosed architecture; and

FIG. 5 illustrates a flow diagram showing exemplary steps performed to protect a meal from contamination using the flexible shield barrier device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a personal protecting device that protects food and beverages served on a plate or personal workspaces from pathogens, and other airborne contaminants. There is also a long felt need in the art for a shield or guarding device that can be used for protecting food, beverages and personal work areas from accidental spills of beverage containers by others. Additionally, there is a long felt need in the art for a personal barrier device that provides an effective barrier from contamination and other airborne particulates while allowing the consumer to consume the food as well as to have a safe and sanitary work area. Moreover, there is a long felt need in the art for a personal shield or guarding device that eliminates the risk to food and the personal workspace being open to the surrounding environment. Further, there is a long felt need in the art for a shield or guard that is lightweight and is easy to carry and use. Finally, there is a long felt need in the art for a personal protection device that helps reduce the spread of germs, viruses, airborne material and bacteria, especially useful in public spaces like a restaurant, bar, offices and other areas where people may gather.

The present invention, in one exemplary embodiment, is a novel personal shield or guarding device. The invention is designed for protecting a meal placed on a plate or other eating space as well as personal work spaces from pathogens and the accidental spill of a drink by others sitting across or nearby the user. The shield or protection device has a dome-shaped angular shield pivotally-coupled to a semi-circular base which is generally flat or forms a planar surface with the surface on which it is positioned. The angular shield is configured to be in a closed position which corresponds to the angular shield making a 10-20 degree angle relative to the base or surface on which it is positioned. The angular shield is also configured to be in an open position which corresponds to the angular shield making a 70-90 degree angle relative to the base or surface on which it is positioned. The angular shield can be secured at any position between the open position of 70 to 90 degrees and the closed position of 10 to 20 degrees.

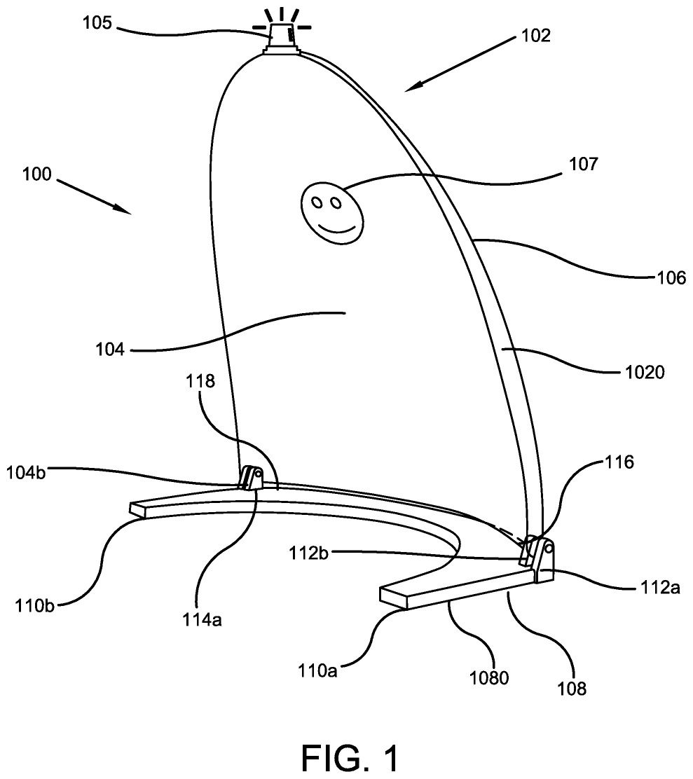

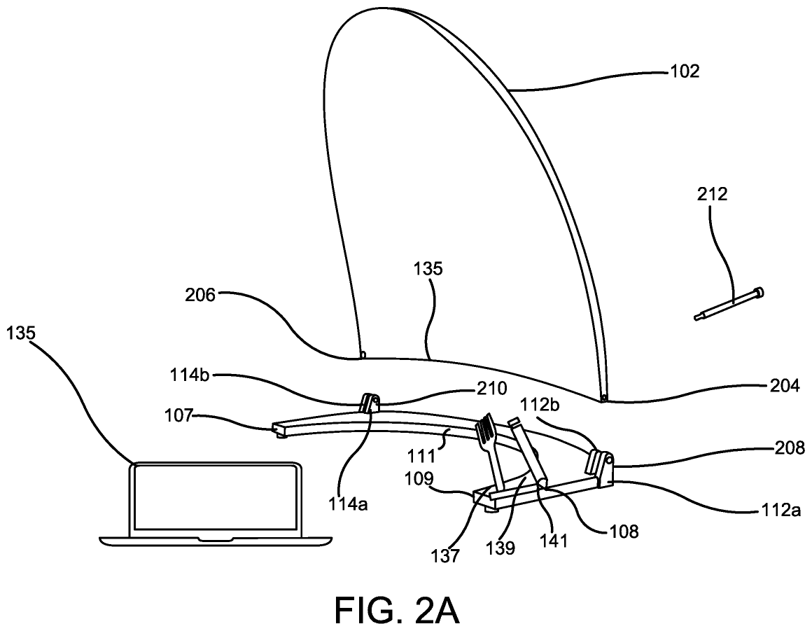

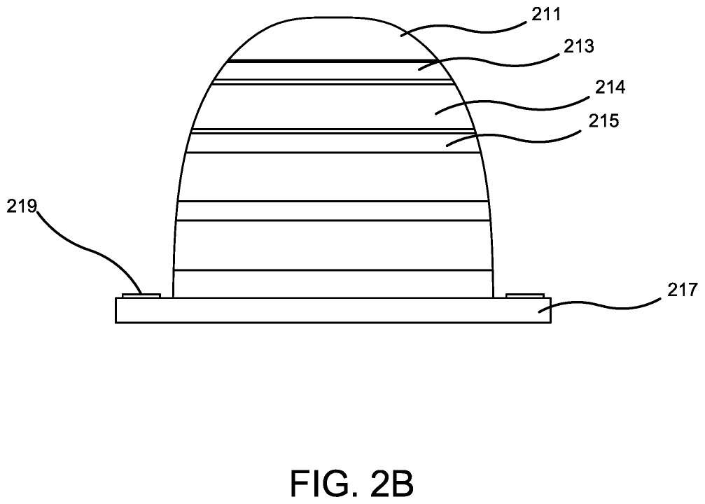

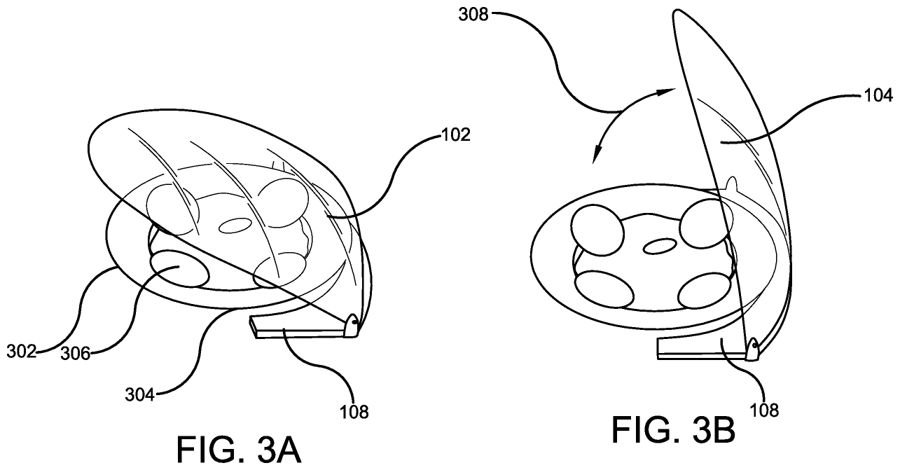

Referring initially to the drawings, FIG. 1 illustrates a perspective view of one potential embodiment of the personal barrier device of the present invention in an assembled state in accordance with the disclosed specification. The personal barrier device 100 in the present embodiment is designed as a flexible shield barrier configured to position around the edge of a plate or a bowl or the work area of an individual. The barrier device 100 shields the plate or bowl having the meal or a laptop, smart phone, book, papers or other work materials to prevent airborne particulates and debris from contaminating the eating or work area. More specifically, the device 100 features two components, an angular adjustable shield 102 and a generally flat semi-circular base 108, both can be integrated or removably-attached to one another. The base 108 has a central area 111 and first and second legs 107 and 109 (see FIG. 2A). In an assembled state, the personal barrier device 100 is ready for installation around the edge of a plate or bowl as best shown in FIGS. 3A and B for protecting a meal or positioning around a workspace. The barrier device 100 has an angular adjustable shield 102 made from a thin, lightweight, and durable plastic or plexiglass. The angular shield 102 has an internal concave surface 104 and an external convex surface 106. The concave curvature of the angular shield 102 increases from the circumferential edge 1020 towards the central portion of the shield 102 to give a dome shape to the angular shield 102. The shield 102 may be provided with graphics or indicia 113 so that the user can personalize the shield as well as a signal indicator 105 such as a light, so that the user can signal for service at a restaurant or to alert a guest to where they are located in a working area.

A semi-circular base 108 is configured to position on a surface such as a table in a secured manner using tabs 110a, 110b on the bottom surface 108. One or more adhesive strips may be used, as will be explained in connection with FIG. 2B. The shape of the base 108 is designed as semi-circular, so that the base can conform to the shape of conventional plates and bowls and can peripherally cover a portion of the plate or bowl or around a work space and cover over a laptop or other items which the individual may be working on. The angular shield 102 is secured to the base 108 using a first pair of hinged slots 112a, 112b positioned at first curved end 116 and a second pair of hinged slots 114a, 114b positioned at the second curved end 118 of the flat base 108. The hinged slots enable the angular shield 102 to pivotally move relative to the base 108 from between a substantially closed position (shown in FIG. 3A) and an open position (FIG. 3B). An advantage of the angular shield 102 is that it can be secured to any desired position between the fully closed position and the fully open position.

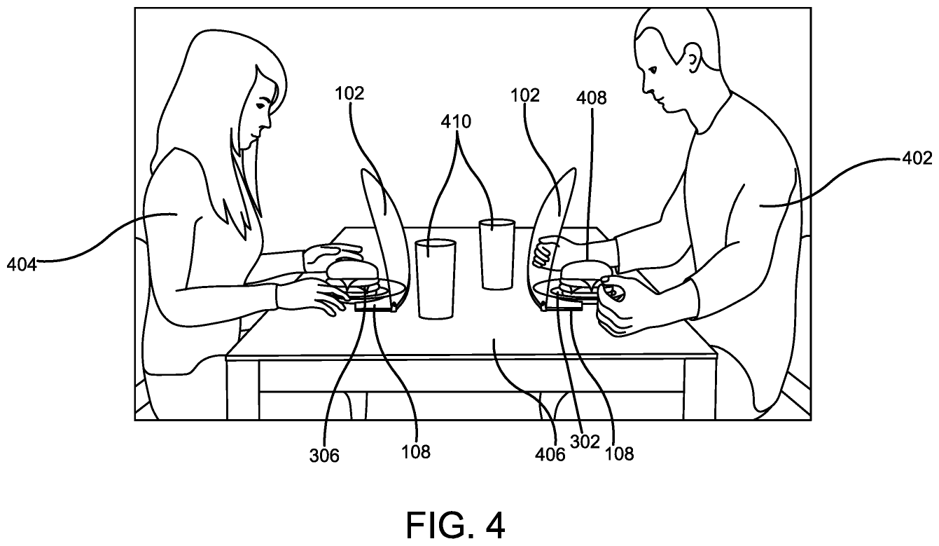

The base 108 sits flat on any surface and balances the angular shield 102. The shield device 100 is positioned such that the angular barrier 102 covers around the edge of the bowl or plate from front to prevent unsanitary particles from reaching food while allowing a consumer to have the meal easily and without any obstruction as best shown in FIG. 4. The curvature of the shield and base also fit well around the working area of an individual. The edge of the angular barrier 102 is smooth and can be held by a user to pivotally move the angular barrier 102.

FIG. 2A illustrates a perspective view of the personal protective device of the present invention in an unassembled state in accordance with the disclosed specification. As stated earlier, the two components, the angular shield 102 and the base 108 can be integrated or removably-attached to each other. The bottom edge 202 of the angular shield 102 has a curvature that conforms to the semi-circular shape of the flat base 108, such that the receiving holes 204, 206 of the angular shield 102 are aligned to the hinge slots 112a, 112b and 114a, 114b respectively. The length of the bottom edge 202 is the same as of the length of the base 108 between the hinges 112, 114.

For securing the angular barrier 102 to the flat base 108, the first hole 204 is positioned between the first pair of hinge slots 112a, 112b and aligns with the hole 208 of the first pair of hinge slots 112a, 112b. Similarly, the second hole 206 is positioned between the second pair of hinge slots 114a, 114b and aligns with the hole 210 of the second pair of hinge slots 114a, 114b. Then, for securing the angular shield 102 to the hinges, a cam-based pin 212 is used with both the pair of hinges. The cam-based pin 212 is used for securing the angular shield 102 to the base 108 and is inserted through the aligned holes 204, 208 and a similar pin is inserted through the aligned holes 206, 210.

In the present invention, the hinged mechanism formed by the cam-based pins used for securing the flat base 108 and the angular shield 102 is configured to hold the angular shield 102 in a desired position (e.g., any position between the closed and open position). A frictional force is exerted on the angular shield 102 so as to maintain the position of the shield 102 when the shield 102 is moved to the desired position. The cam-based pin 212 generates a frictional force that prevents slipping out of position of the angular shield 102. The base 108 may have a slot or other receptacle 141 for receiving eating utensils 137 or items required for work 139. The personal shield may also be used for protecting a personal workspace such as a laptop 135 which fits behind the curvature of the shield or guard.

FIG. 2B shows the base 217 having one or more feet 219 to help secure the guard to the surface, The feet 219 may be rubberized feet to prevent the base from slipping. In another embodiment a series of release liners 211, 214 cover adhesive strips 213, 215. Removing a carrier layer exposes a repositionable adhesive which helps to hold the base to the surface on which it is positioned. By providing a series of release layers and adhesive layers, the user can remove layers to help improve the sanitary nature of the shield or guard.

FIG. 3A illustrates a perspective view of the personal protective device of the present invention in a closed state in accordance with the disclosed specification. For providing maximum protection to an eating area or work space from pathogens, germs, airborne impurities, particulate matter and other contamination, the angular shield 102 is positioned in a closed position that corresponds to the angular shield orientation substantially covering the meal 306 and making a 10-20 degree angle with the flat base 108. This allows the angular shield 102 to cover the plate 302 and the food 306 substantially without touching the food due to the dome shape of the angular shield 102. The shield device 100 is positioned on the front of the plate 302 so as to cover the front and sides of the plate. The front of the plate 302 is defined as the portion of the plate opposite to a consumer who is consuming meal from the plate 302 as best shown in FIG. 4. This allows the consumer to have a meal 306 without any obstruction or hinderance while protecting the meal 306 from pathogens, germs and any unwanted spillage or spatter.

The shield 100 is placed on the flat base 108 and the rim 304 of the front of the plate 302 lies above the flat base 108 so that shield device 100 can be easily removed as per the preferences and need of the users. The size of the angular barrier 102 is preferably large enough to cover the plate or bowl 302 so that the meal 306 does not remain open when the shield device 100 is in the closed position. The closed position is intended for the cases where a consumer may want to leave the meal in-between for going to a restroom or while attending a call, for example.

FIG. 3B illustrates a perspective view of the personal protective device of the present invention in an open state in accordance with the disclosed specification. For allowing a consumer to have a meal 306 while protecting the meal 306 from pathogens, the angular shield 102 is positioned in an open position that corresponds to the angular shield orientation making a 70-90 degree angle relative to the flat base 108. This allows a consumer to have the meal 306 while the meal 306 is protected from the front. The configuration also protects a work space which may hold a laptop or other items that an individual may be working on.

To configure the angular shield 102 from the closed state to the open state one must by pivotally lift the angular shield 102 as shown by the direction 308 and secure the angular shield 102 at the desired angular position. The flat base 108 remains static and does not slip while the angular barrier 102 is pivotally-moved relative to the flat base 108.

FIG. 4 illustrates a side perspective view showing two consumers consuming meals from their respective plates protected with the respective flexible shield barrier of the present invention in accordance with the disclosed architecture. As shown, a first consumer 402 is consuming a burger 408 while the burger 408 is shielded from the front by the angular shield 102 for protection from any pathogens and from accidental spill from the beverage container 410. The shield device 100 is placed on the table 406 covering a portion of the plate 302 and the burger 408. When the first consumer 402 wants to go or protect the burger 408, then the angular shield 102 can be positioned in a closed orientation as described in FIG. 3A.

A second consumer 404 can similarly consume the meal 306 while protecting the meal 306 from pathogens and accidental spill from the beverage containers 410. It should be appreciated that the shield protects the meal from any sneezing, coughing or other airborne contaminants of the consumer or other individual sitting in front of the other consumer who is consuming the food. This is especially useful in cases where the users may have communicable diseases and in the times of pandemic such as Covid-19.

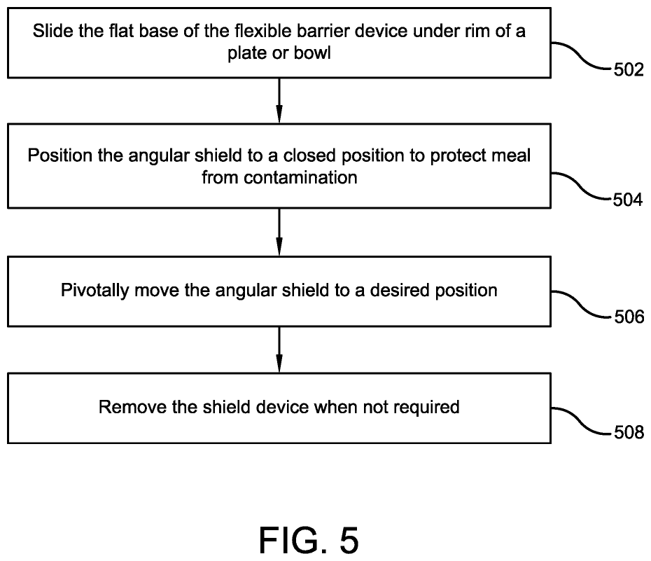

FIG. 5 illustrates a flow diagram showing exemplary steps performed to protect a meal or workspace from contamination using a flexible shield barrier device of the present invention in accordance with the disclosed specification. Initially, placing the shield device in front of a plate or bowl or workspace, the flat base with attached angular shield is slid under rim of the plate or in front of the work area such that the flat base conforms to the shape of the plate or bowl (Step 502). Then, the angular shield is placed in the closed position to substantially cover the plate/bowl or workspace and the meal to protect from contamination (Step 504). This can be useful in restaurants, homes and offices to protect meals while serving or in a workspace while an individual is working. Thereafter, for consuming the meal, or using the work area, the angular shield is pivotally-oriented to an open position (Step 506). Finally, the shield device can be removed when the meal is finished and the plate is to be washed or otherwise disposed (Step 508).

The shield device 100 of various embodiments can come in various sizes, designs, colors and configurations and a thickness to fit conventional plates and bowls of all sizes. The material of the flat base 108 can be BPA and phthalate-free plastic or cardboard. The angular shield 102 can be made from BPA and phthalate-free plastic or plexiglass. The shield device may be transparent, translucent or opaque.

The flexible shield device 100 of the present invention has the advantages that its structural design is compact, has simple manufacturing and is convenient to use. The design does not hinder having a meal or working in an area while providing adequate protection from pathogens.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “shield device”, “flexible shield device”, “flexible shield barrier device”, “meal barrier device”, and “device”, are interchangeable and refer to the meal shield device 100 of the present invention.

Notwithstanding the forgoing, the meal shield device 100 of the present invention can be of any suitable size and configuration as is known in the art without affecting the overall concept of the invention, provided that it accomplishes the above-stated objectives. One of ordinary skill in the art will appreciate that the size, configuration and material of the meal shield device 100 as shown in the FIGS. are for illustrative purposes only, and that many other sizes and shapes of the meal shield device 100 are well within the scope of the present disclosure. Although the dimensions of the meal shield device 100 are important design parameters for user convenience, the meal shield device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A personal protection device comprising:
a base having a central portion and first and second legs;
a pair of hinge slots extending upwards from the base; and
a shield having a pair of receiving holes that correspond to the pair of hinge slots on the base, wherein the shield comprises a concave shape.

2. The personal protection device as recited in claim 1, wherein at least one of the first and second legs comprises a slot for receiving a utensils or an accessory.

3. The personal protection device as recited in claim 1, wherein the shield is comprised of a transparent or a translucent material.

4. The personal protection device as recited in claim 1, wherein the shield comprises at least one of a graphic or an indicia.

5. The personal protection device as recited in claim 1, wherein the shield comprises a signal indicator.

6. The personal protection device as recited in claim 5, wherein the signal indicator is an LED light.

7. The personal protection device as recited in claim 1, wherein the shield has a semi-circular shape.

8. The personal protection device as recited in claim 1, wherein the pair of hinge slots are positioned in alignment with the pair of receiving holes, and a pin is inserted into each of the pair of receiving holes and the pair of hinge slots.

9. The personal protection device as recited in claim 1, wherein the shield is repositionable between a first position and a second position.

10. The personal protection device as recited in claim 9, wherein the first position is an open position and the second position is a closed position.

11. A meal shielding device comprising:
a semi-circular base having a central portion and first and second legs; and
a shield portion connected to the semi-circular base but a pair of hinge slots, wherein the shield portion is repositionable between an open position and a closed position, and further wherein the closed position creates an angle of between 10 and 20 degrees between the shield portion and the semi-circular base and the open position creates an angle of between 70 and 90 degrees between the shield portion and the semi-circular base.

12. The meal shielding device as recited in claim 11, wherein the shield portion is comprised of a transparent or translucent material.

13. The meal shielding device as recited in claim 11, wherein the shield portion has a concave interior shape.

14. The meal shielding device as recited in claim 11, wherein the shield portion comprises at least one of an indicia or a graphic.

15. The meal shielding device as recited in claim 11, wherein the shield portion comprises an indicator signal.

16. The meal shielding device as recited in claim 11, wherein the shield portion is removably attached to the semi-circular base by at least one receiving hole, pin and hinge slot.

17. The meal shielding device as recited in claim 11, wherein semi-circular base fits around a periphery of a bowl or a plate.

18. The meal shielding device as recited in claim 11, wherein semi-circular base is comprised of at least one of a removable adhesive layer and release liner and a pair of rubberized feet.

19. A guard for a personal space, the guard comprising:
a concave shield movable from a first position to a second position;
a semi-circular based having a central portion and first and second legs, the semi-circular based connects to the concave shield but a pair of hinge points;
at least one of an adhesive layer or rubberized feet on the semi-circular base; and
the concave shield when in the first position forms an angle with the semi-circular base ranging between 70 to 90 degrees and when in the second position forms an angle with the semi-circular base ranging between 10 to 20 degrees.

20. The guard for a personal space as recited in claim 1, wherein the concave shield is comprised of an opaque material and at least one of an indicia or a graphic.
